(19) United States
(12) Patent Application Publication
(10) Pub. No.: US 2026/0189505 A1
(43) Pub. Date: Jul. 2, 2026

(54) ADAPTIVE BACKPRESSURE IN A NETWORK DEVICE

(71) Applicant: Marvell Asia Pte Ltd, Singapore (SG)

(72) Inventors: Bruce KWAN, Sunnyvale, CA (US); William Brad MATTHEWS, Los Gatos, CA (US)

(21) Appl. No.: 18/762,113

(22) Filed: Jul. 2, 2024

(51) Int. Cl. H04L 47/11; H04L 47/122; H04L 47/30

(52) U.S. Cl. CPC H04L 47/11; H04L 47/122; H04L 47/30

(57) ABSTRACT

A network device monitors a buffer memory to detect congestion corresponding to data units received from multiple sources within the network device. In response to detecting congestion in the buffer memory, first messages are sent to the multiple sources, the first messages indicating that the multiple sources are to pause sending data units that are destined for the buffer memory. In response to determining that the congestion corresponding has ended, second messages are sent to the multiple sources, the second messages indicating that the multiple sources are to resume sending data units that are destined for the buffer memory. Circuitry limits a quantity of the second messages that are sent to the multiple sources during a particular time period to a maximum quantity such that one or more second messages are not sent to a subset of sources among the multiple sources during the time period.

### FIELD OF TECHNOLOGY

The present disclosure relates generally to communication networks, and more particularly to buffering data units within a network device.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A computer network is a set of computing components interconnected by communication links. Each computing component may be a separate computing device, such as, without limitation, a hub, a switch, a bridge, a router, a server, a gateway, or personal computer, or a component thereof. Each computing component, or “network device,” is considered to be a node within the network. A communication link is a mechanism of connecting at least two nodes such that each node may transmit data to and receive data from the other node. Such data may be transmitted in the form of signals over transmission media such as, without limitation, electrical cables, optical cables, or wireless media.

The structure and transmission of data between nodes is governed by a number of different protocols. There may be multiple layers of protocols, typically beginning with a lowest layer, such as a “physical” layer that governs the transmission and reception of raw bit streams as signals over a transmission medium. Each layer defines a data unit (the protocol data unit, or “PDU”), with multiple data units at one layer combining to form a single data unit in another. Additional examples of layers may include, for instance, a data link layer in which bits defined by a physical layer are combined to form a frame or cell, a network layer in which frames or cells defined by the data link layer are combined to form a packet, and a transport layer in which packets defined by the network layer are combined to form a Transmission Control Protocol (TCP) segment or a User Datagram Protocol (UDP) datagram. The Open Systems Interconnection (OSI) model of communications describes these and other layers of communications. However, other models defining other ways of layering information may also be used. The Internet Protocol (IP) suite, or “TCP/IP stack,” is one example of a common group of protocols that may be used together over multiple layers to communicate information. However, techniques described herein may have application to other protocols outside of the TCP/IP stack.

A given node in a network may not necessarily have a link to each other node in the network, particularly in more complex networks. For example, in wired networks, each node may only have a limited number of physical ports into which cables may be plugged to create links. Certain “terminal” nodes—often servers or end-user devices—may only have one or a handful of ports. Other nodes, such as switches, hubs, or routers, may have a great deal more ports, and typically are used to relay information between the terminal nodes. The arrangement of nodes and links in a network is said to be the topology of the network, and is typically visualized as a network graph or tree.

A given node in the network may communicate with another node in the network by sending data units along one or more different “paths” through the network that lead to the other node, each path including any number of intermediate nodes. The transmission of data across a computing network typically involves sending units of data, such as packets, cells, or frames, along paths through intermediary networking devices, such as switches or routers, that direct or redirect each data unit towards a corresponding destination.

While a data unit is passing through an intermediary networking device—a period of time that is conceptualized as a “visit” or “hop”—the device may perform any of a variety of actions, or processing steps, with the data unit. The exact set of actions taken will depend on a variety of characteristics of the data unit, such as metadata found in the header of the data unit, and in many cases the context or state of the network device. For example, address information specified by or otherwise associated with the data unit, such as a source address, destination address, a virtual local area network (VLAN) identifier, path information, etc., is typically used to determine how to handle a data unit (i.e., what actions to take with respect to the data unit). For instance, an IP data packet may include a destination IP address field within the header of the IP data packet, based upon which a network router may determine one or more other networking devices, among a number of possible other networking devices, to which the IP data packet is to be forwarded.

In these and other contexts, a network device or other computing device often needs to temporarily store data in one or more memories or other storage media until resources become available to process the data. The storage media in which such data is temporarily stored is often logically and/or physically divided into discrete regions or sections referred to as data buffers (or, simply, “buffers”). The rules and logic utilized to determine which data is stored in what buffer is a significant system design concern having a variety of technical ramifications, including without limitation the amount of storage media needed to implement buffers, the speed of that media, how that media is interconnected with other system components, and/or the manner in the buffered data is queued and processed.

### SUMMARY

In an embodiment, a network device comprises: a plurality of network interfaces; a plurality of packet processors configured to process data units received via the plurality of network interfaces to determine network interfaces, among the plurality of network interfaces, that are to transmit the data units; a plurality of buffer memories; a plurality of queues corresponding to the plurality of buffer memories, the plurality of queues configured to store data units received via the plurality of network interfaces while the data units are being processed by the plurality of packet processors; and first circuitry. The first circuitry is configured to: monitor the plurality of buffer memories to detect congestion corresponding to data units received from a plurality of sources; in response to detecting congestion corresponding to a first queue among the plurality of queues, send first messages to multiple sources that are sending data units that are being stored in the first queue, the first messages indicating that the multiple sources are to pause sending data units that are destined for the first queue; in response to determining that the congestion corresponding to the first queue has ended, send second messages to the multiple sources, the second messages indicating that the multiple sources are to resume sending data units that are destined for the first queue; and limit a quantity of the second messages that are sent to the multiple sources during a time period to a maximum quantity such that one or more second messages are sent to a first subset of sources among the multiple sources during the time period and no second messages are sent to a second subset of sources among the multiple sources during the time period.

In another embodiment, a method for processing data units in a network device includes receiving data units at a plurality of network interfaces of the network device; storing data units received at the plurality of network interfaces in a plurality of queues while the data units are processed by one or more processors of the network device, the plurality of queues corresponding to one or more buffer memories; monitoring, by the network device, the plurality of buffer memories to detect congestion corresponding to data units received from a plurality of sources; in response to detecting congestion corresponding to a first queue among the plurality of queues, sending, by circuitry of the network device, first messages to multiple sources that are sending data units that are being stored in the first queue, the first messages indicating that the multiple sources are to pause sending data units that are destined for the first queue; in response to determining that the congestion corresponding to the first queue has ended, sending, by the circuitry, second messages to the multiple sources, the second messages indicating that the multiple sources are to resume sending data units that are destined for the first queue; and limiting, by the circuitry, a quantity of the second messages that are sent to the multiple sources during a time period to a maximum quantity such that one or more second messages are sent to a first subset of sources among the multiple sources during the time period and no second messages are sent to a second subset of sources among the multiple sources during the time period.

### BRIEF DESCRIPTION OF THE DRAWINGS

FIG. 1 is a simplified diagram of an example networking system in which adaptive backpressure techniques described herein are practiced, according to an embodiment.

FIG. 2A is a simplified block diagram of an example network device in which adaptive backpressure techniques are utilized, according to an embodiment.

FIG. 2B is a simplified block diagram of example adaptive backpressure circuitry of the network device of FIG. 2A, according to an embodiment.

FIG. 2C is timing diagram illustrating an example operation of the adaptive backpressure circuitry of FIG. 2B, according to an embodiment.

FIG. 3A is a simplified block diagram of a set of counters maintained by the network device of FIG. 2A, according to an embodiment.

FIG. 3B is a simplified block diagram of another set of counters maintained by the network device of FIG. 2A, according to another embodiment.

FIG. 4 is a simplified block diagram of the network device of FIG. 2A showing flows of packets through the network device, according to an embodiment.

FIG. 5A is a plot illustrating an example of respective limits on a quantity of messages (which indicate transfer of packets between components of the network device of FIG. 2A can resume) for different time periods T1 through T12, according to an embodiment.

FIG. 5B is a plot illustrating another example of respective limits on a quantity of messages (which indicate transfer of packets between components of the network device of FIG. 2A can resume) for different time periods T1 through T12, according to another embodiment.

FIG. 6 is a flow diagram of an example method for processing data units in a network device, such as the network device of FIG. 2A, according to an embodiment.

### DETAILED DESCRIPTION

In the following description, for the purposes of explanation, numerous specific details are set forth in order to provide a thorough understanding of the present inventive subject matter. It will be apparent, however, that the present inventive subject matter may be practiced without these specific details. In other instances, well-known structures and devices are shown in block diagram form in order to avoid unnecessarily obscuring the present inventive subject matter.

Example approaches, techniques, and mechanisms for more optimally transferring data within a network device, such as within a switch or router, are disclosed herein.

Incoming data units, such as packets, frames, cells, etc., are temporarily stored in one or more ingress buffers while the data units are processed by an ingress processor of the network device, e.g., to determine one or more network interfaces via which the data units are to be transmitted by the network device (sometimes referred to herein as “target network interfaces”), according to some embodiments. Then, the data units are transferred to one or more egress buffers associated with the target network interfaces and temporarily stored until the data units can be transmitted via the target network interfaces, according to some embodiments.

First circuitry associated with the egress buffers monitors the egress buffers for congestion and sends to second circuitry associated with sources (e.g., port/priority set pairs, ports, etc.) that are providing packets to the egress buffers flow control messages indicative of congestion of egress buffers, according to some embodiments. Such messages prompt the second circuitry to pause the sources sending data units to egress buffers that are congested, in an embodiment. For each of at least some egress buffers, the first circuitry is configured control a number of sources, during a time period, that are permitted to resume transferring data units to the egress buffer when congestion of the egress buffer has eased, in some embodiments. For example, the first circuitry is configured to, for each of at least some of the egress buffers, control a number of no congestion messages that can be sent to sources during a time period, each no congestion message corresponding to a respective source (e.g., a port/priority set pair, a port, etc.) and indicating that transfer of data units from the source to the egress buffer can be resumed, in some embodiments. The first circuitry described above is sometimes referred to herein as “adaptive backpressure circuitry.”

In some embodiments that utilize the first circuitry and second circuitry described above, bursting of traffic to egress buffers is reduced, which enables the sizes of the egress buffers to be reduced.

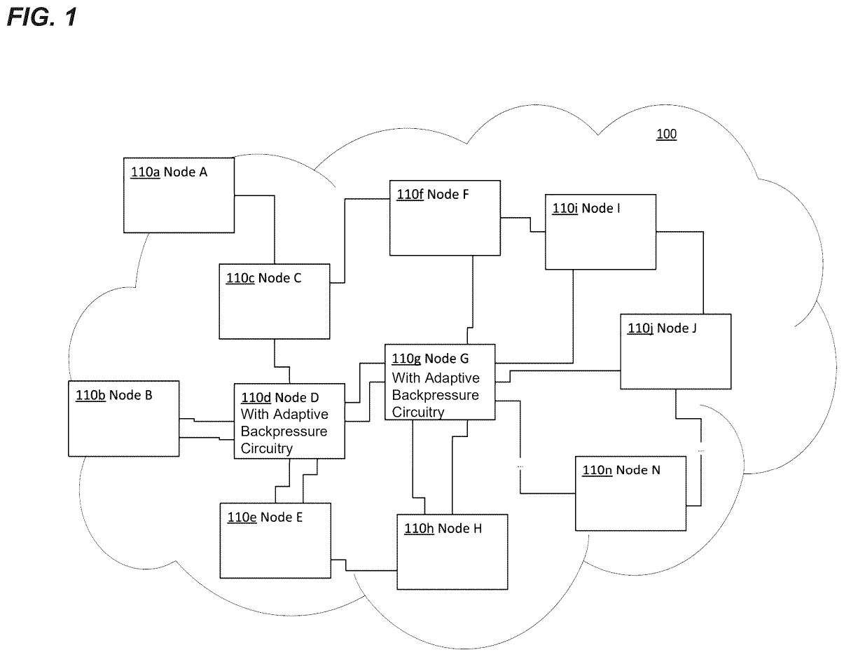

FIG. 1 is a simplified diagram of an example networking system 100, also referred to as a network, in which the techniques described herein are practiced, according to an embodiment. Networking system 100 comprises a plurality of interconnected nodes 110 a-110 n (collectively nodes 110), each implemented by a different computing device. For example, a node 110 may be a single networking computing device, such as a router or switch, in which some or all of the processing components described herein are implemented in application-specific integrated circuits (ASICs), field programmable gate arrays (FPGAs), or other integrated circuit(s). As another example, a node 110 may include one or more memories storing machine-readable instructions for implementing various components described herein, one or more hardware processors configured to execute the instructions stored in the one or more memories, and various data repositories in the one or more memories for storing data structures utilized and manipulated by the various components.

Each node 110 is connected to one or more other nodes 110 in network 100 by one or more communication links, depicted as lines between nodes 110. The communication links may be any suitable wired cabling or wireless links. Note that system 100 illustrates only one of many possible arrangements of nodes within a network. Other networks may include fewer or additional nodes 110 having any number of links between them.

While each node 110 may or may not have a variety of other functions, in an embodiment, each node 110 is configured to send, receive, and/or relay data to one or more other nodes 110 via communication links. In general, data is communicated as a series of discrete units or structures of data represented by signals transmitted over the communication links.

When a node 110 receives a data unit, it typically examines addressing information within the data unit (and/or other information within the data unit) to determine how to process the data unit. The addressing information may include, for instance, a media access control (MAC) address, an IP address, a VLAN identifier, information within a multi-protocol label switching (MPLS) label, or any other suitable information. If the addressing information indicates that the receiving node 110 is not the destination for the data unit, the node may look up forwarding information within a forwarding database of the receiving node 110 and forward the data unit to one or more other nodes 110 connected to the receiving node 110 based on the forwarding information. The forwarding information may indicate, for instance, an outgoing port over which to send the data unit, a header to attach to the data unit, a new destination address to overwrite in the data unit, etc. In cases where multiple paths to the destination node 110 are possible, the forwarding information may include information indicating a suitable approach for selecting one of those paths, or a path deemed to be the best path may already be defined.

Addressing information, flags, labels, and other metadata used for determining how to handle a data unit are typically embedded within a portion of the data unit known as the header. One or more headers are typically at the beginning of the data unit, and are followed by the payload of the data unit. For example, a first data unit having a first header corresponding to a first communication protocol may be encapsulated in a second data unit at least by appending a second header to the first data unit, the second header corresponding to a second communication protocol. For example, the second communication protocol is below the first communication protocol in a protocol stack, in some embodiments.

A header has a structure defined by a communication protocol and comprises fields of different types, such as a destination address field, a source address field, a destination port field, a source port field, and so forth, according to some embodiments. In some protocols, the number and the arrangement of fields is fixed. Other protocols allow for variable numbers of fields and/or variable length fields with some or all of the fields being preceded by type information that indicates to a node the meaning of the field and/or length information that indicates a length of the field. In some embodiments, a communication protocol defines a header having multiple different formats and one or more values of one or more respective fields in the header indicate to a node the format of the header. For example, a header includes a type field, a version field, etc., that indicates to which one of multiple formats that header conforms.

Different communication protocols typically define respective headers having respective formats.

For convenience, data units are sometimes referred to herein as “packets,” which is a term often used to refer to data units defined by the IP. The approaches, techniques, and mechanisms described herein, however, are applicable to data units defined by suitable communication protocols other than the IP. Thus, unless otherwise stated or apparent, the term “packet” as used herein should be understood to refer to any type of data structure communicated across a network, including packets as well as segments, cells, data frames, datagrams, and so forth.

Any node in the depicted network 100 may communicate with any other node in the network 100 by sending packets through a series of nodes 110 and links, referred to as a path. For example, Node B (110b) may send packets to Node H (110h) via a path from Node B to Node D to Node E to Node H. There may be a large number of valid paths between two nodes. For example, another path from Node B to Node H is from Node B to Node D to Node G to Node H.

In an embodiment, a node 110 does not actually need to specify a full path for a packet that it sends. Rather, the node 110 may simply be configured to calculate the best path for the packet out of the device (e.g., via which one or more egress ports should send the packet be transmitted). When a node 110 receives a packet that is not addressed directly to the node 110, based on header information associated with a packet, such as path and/or destination information, the node 110 relays the packet along to either the destination node 110, or a “next hop” node 110 that the node 110 calculates is in a better position to relay the packet to the destination node 110, according to some embodiments. In this manner, the actual path of a packet is product of each node 110 along the path making routing decisions about how best to move the packet along to the destination node 110 identified by the packet, according to some embodiments.

As data units are routed through different nodes in a network, the nodes may, on occasion, discard, fail to send, or fail to receive data units, thus resulting in the data units failing to reach their intended destination. The act of discarding of a data unit, or failing to deliver a data unit, is typically referred to as “dropping” the data unit. Instances of dropping a data unit, referred to herein as “drops” or “packet loss,” may occur for a variety of reasons, such as resource limitations, errors, or deliberate policies.

One or more of the nodes 110 include adaptive backpressure circuitry, examples of which are described below. For example, FIG. 1 depicts node 110d and node 110g as including adaptive backpressure circuitry.

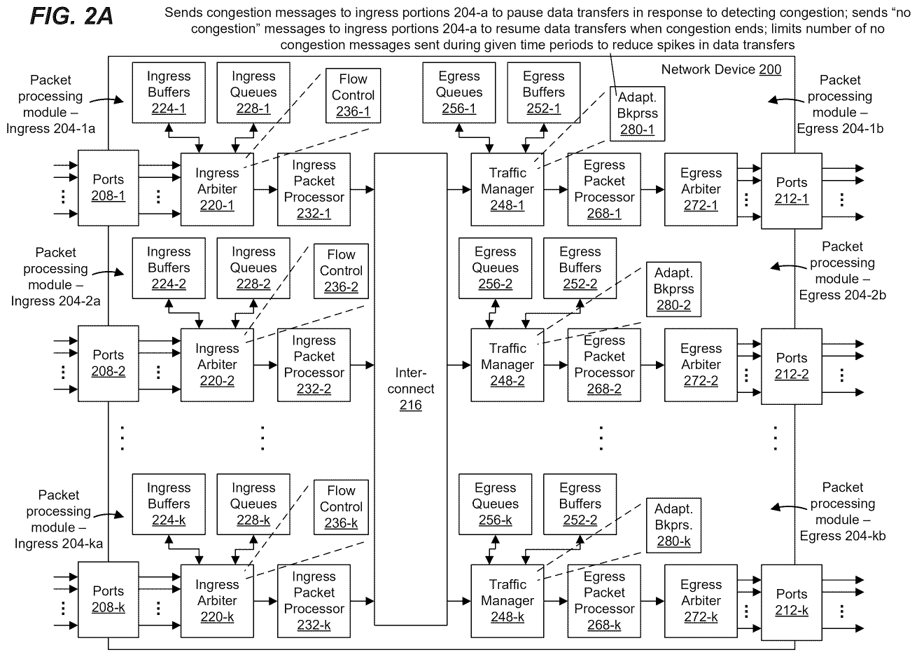

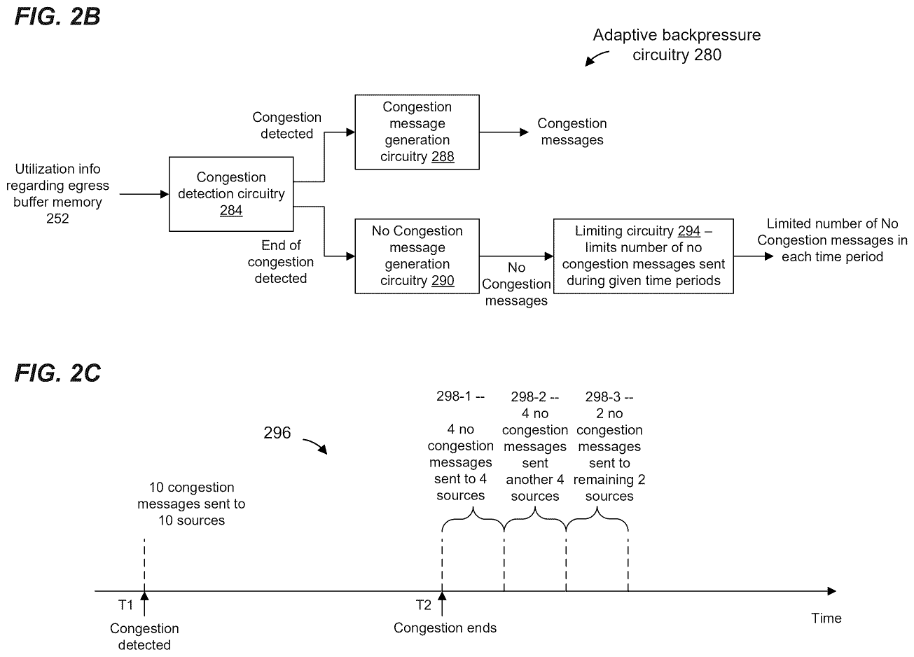

FIG. 2A is a simplified diagram of an example network device 200 that include adaptive backpressure circuitry, according to an embodiment. The network device 200 is a computing device comprising any combination of i) hardware and/or ii) one or more processors executing machine-readable instructions, being configured to implement the various logical components described herein.

The adaptive backpressure circuitry monitors buffers of the network device 200 for congestion and, in response to detecting congestion of a buffer, sends internal congestion messages to components of the network device 200 that are sending packet data to the buffer, according to some embodiments. In response to detecting that congestion of the buffer has ended, the adaptive backpressure circuitry begins sending “no congestion” messages to the components of the network device 200 that that have paused sending packet data to the buffer, where the no congestion messages prompt the components to resume sending packet data to the buffer, according to some embodiments. The adaptive backpressure circuitry controls a number of no congestion messages that can be sent to sources of packet data during a given time period, which mitigates flooding of packet data to the buffer when congestion ends and helps to reduce a size of the buffer, at least in some embodiments.

In some embodiments, the node 110d and node 110g of FIG. 1 have a structure the same as or similar to the network device 200. In another embodiment, the network device 200 may be one of a number of components within a node 110. For instance, network device 200 may be implemented on one or more integrated circuits, or “chips,” configured to perform switching and/or routing functions within a node 110, such as a network switch, a router, etc. The node 110 may further comprise one or more other components, such as one or more central processor units, storage units, memories, physical interfaces, LED displays, or other components external to the one or more chips, some or all of which may communicate with the one or more chips. In some such embodiments, the node 110 comprises multiple network devices 200.

In other embodiments, the network device 200 is utilized in a suitable networking system different than the example networking system 100 of FIG. 1.

The network device 200 includes a plurality of packet processing modules 204, with each packet processing module being associated with a respective plurality of ingress network interfaces 208 (sometimes referred to herein as “ingress ports” for purposes of brevity) and a respective plurality of egress network interfaces 212 (sometimes referred to herein as “egress ports” for purposes of brevity). The ingress ports 208 are ports by which packets are received via communication links in a communication network, and the egress ports 212 are ports by which at least some of the packets are transmitted via the communication links after having been processed by the network device 200.

Although the term “packet” is sometimes used herein to describe the data units processed by the network device 200, the data units may be packets, cells, frames, or other suitable structures. For example, in some embodiments the individual atomic data units upon which the depicted components operate are cells or frames. That is, data units are received, acted upon, and transmitted at the cell or frame level, in some such embodiments. These cells or frames are logically linked together as the packets to which they respectively belong for purposes of determining how to handle the cells or frames, in some embodiments. However, the cells or frames are not actually assembled into packets within device 200, particularly if the cells or frames are being forwarded to another destination through device 200, in some embodiments.

Ingress ports 208 and egress ports 212 are depicted as separate ports for illustrative purposes, but typically correspond to the same physical network interfaces of the network device 200. That is, a single network interface acts as both an ingress port 208 and an egress port 212, in some embodiments. Nonetheless, for various functional purposes, certain logic of the network device 200 may view a single physical network interface as logically being a separate ingress port 208 and egress port 212. Moreover, for various functional purposes, certain logic of the network device 200 may subdivide a single physical network interface into multiple ingress ports 208 or egress ports 212 (e.g., “virtual ports”), or aggregate multiple physical network interfaces into a single ingress port 208 or egress port 212 (e.g., a trunk, a link aggregate group (LAG), an equal cost multipath (ECMP) group, etc.). Hence, in various embodiments, ingress ports 208 and egress ports 212 are considered distinct logical constructs that are mapped to physical network interfaces rather than simply as distinct physical constructs.

In some embodiments, at least some ports 208/212 are coupled to one or more transceivers (not shown in FIG. 2A), such as Serializer/Deserializer (“SerDes”) blocks. For instance, ingress ports 208 provide serial inputs of received data units into a SerDes block, which then outputs the data units in parallel into a packet processing module 204. On the other end, a packet processing module 204 provides data units in parallel into another SerDes block, which outputs the data units serially to egress ports 212. There may be any number of input and output SerDes blocks, of any suitable size, depending on the specific implementation (e.g., four groups of 4×25 gigabit blocks, eight groups of 4×100 gigabit blocks, etc.).

Each packet processing module 204 comprises an ingress portion 204-xa and an egress portion 204-xb. The ingress portion 204-xa generally performs ingress processing operations for packets such as one of, or any suitable combination of two or more of: packet classification, tunnel termination, Layer-2 (L2) forwarding lookups, Layer-3 (L3) forwarding lookups, etc.

The egress portion 204-xb generally performs egress processing operations for packets such as one of, or any suitable combination of two or more of: packet duplication (e.g., for multicast packets), header alteration, rate limiting, traffic shaping, egress policing, flow control, maintaining statistics regarding packets, etc.

Each ingress portion 204-xa is communicatively coupled to multiple egress portions 204-xb via an interconnect 216. Similarly, each egress portion 204-xb is communicatively coupled to multiple ingress portions 204-xa via the interconnect 216. The interconnect 216 comprises one or more switching fabrics, one or more crossbars, etc., according to various embodiments.

In operation, an ingress portion 204-xa receives a packet via an associated ingress port 208 and performs ingress processing operations for the packet, including determining one or more egress ports 212 via which the packet is to be transmitted (sometimes referred to herein as “target ports”). The ingress portion 204-xa then transfers the packet, via the interconnect 216, to one or more egress portion 204-xb corresponding to the determined one or more target ports 212. Each egress portion 204-xb that receives the packet performs egress processing operations for the packet and then transfers the packet to one or more determined target ports 212 associated with the egress portion 204-xb for transmission from the network device 200.

In some embodiments, the ingress portion 204-xa determines a virtual target port and one or more egress portions 204-xb corresponding to the virtual target port map the virtual target portion to one or more physical egress ports 212. In some embodiments, the ingress portion 204-xa determines a group of target ports 212 (e.g., a trunk, a LAG, an ECMP group, etc.) and one or more egress portions 204-xb corresponding to the group of target ports selects one or more particular target egress ports 212 within the group of target ports. In the present disclosure, the term “target port” refers to a physical port, a virtual port, a group of target ports, etc., unless otherwise stated or apparent.

Each packet processing module 204 is implemented using any suitable combination of fixed circuitry and/or a processor executing machine-readable instructions, such as specific logic components implemented by one or more FPGAs, ASICs, or one or more processors executing machine-readable instructions, according to various embodiments.

In some embodiments, at least respective portions of multiple packet processing modules 204 are implemented on a single IC (or “chip”). In some embodiments, respective portions of multiple packet processing modules 204 are implemented on different respective chips.

In an embodiment, at least some components of each ingress portion 204-xa are arranged in a pipeline such that outputs of one or more components are provided as inputs to one or more other components. In some embodiments in which the components are arranged in a pipeline, one or more components of the ingress portion 204-xa are skipped or bypassed for certain packets. In other embodiments, the components are arranged in a suitable manner that is not a pipeline. The exact set and/or sequence of components that process a given packet may vary, in some embodiments, depending on the attributes of the packet and/or the state of the network device 200, in some embodiments.

Similarly, in an embodiment, at least some components of each egress portion 204-xb are arranged in a pipeline such that outputs of one or more components are provided as inputs to one or more other components. In some embodiments in which the components are arranged in a pipeline, one or more components of the egress portion 204-xb are skipped or bypassed for certain packets. In other embodiments, the components are arranged in a suitable manner that is not a pipeline. The exact set and/or sequence of components that process a given packet may vary, in some embodiments, depending on the attributes of the packet and/or the state of the network device 200, in some embodiments.

Each ingress portion 204-xa includes circuitry 220 (sometimes referred to herein as “arbitration circuitry”) that is configured to reduce traffic loss during periods of bursty traffic and/or other congestion. In some embodiments, the arbitration circuitry 220 is configured to function in a manner that facilitates economization of the sizes, numbers, and/or qualities of downstream components within the packet processing module 204 by more intelligently controlling the release of data units to these components. In some embodiments, the arbitration circuitry 220 is further configured to support features such as lossless protocols and cut-through switching while still permitting high rate bursts from ports 208.

The arbitration circuitry 220 is coupled to an ingress buffer memory 224 that is configured to temporarily store packets that are received via the ports 208 while components of the packet processing module 204 process the packets.

Each data unit received by the ingress portion 204-xa is stored in one or more entries within one or more buffers, which entries are marked as utilized to prevent newly received data units from overwriting data units that are already buffered in the buffer memory 224. After a data unit is released to an egress portion 204-xb, the one or more entries in which a data unit is buffered in the ingress buffer memory 224 are then marked as available for storing newly received data units, in some embodiments.

Each buffer may be a portion of any suitable type of memory, including volatile memory and/or non-volatile memory. In an embodiment, the ingress buffer memory 224 comprises a single-ported memory that supports only a single input/output (I/O) operation per clock cycle (i.e., either a single read operation or a single write operation). Single-ported memories are utilized for higher operating frequency, though in other embodiments multi-ported memories are used instead. In an embodiment, the ingress buffer memory 224 comprises multiple physical memories that are capable of being accessed concurrently in a same clock cycle, though full realization of this capability is not necessary. In an embodiment, each buffer is a distinct memory bank, or set of memory banks. In yet other embodiments, different buffers are different regions within a single memory bank. In an embodiment, each buffer comprises many addressable “slots” or “entries” (e.g., rows, columns, etc.) in which data units, or portions thereof, may be stored.

Generally, buffers in the ingress buffer memory 224 comprises a variety of buffers or sets of buffers, each utilized for varying purposes and/or components within the ingress portion 204-xa.

The ingress portion 204-xa comprises a buffer manager (not shown) that is configured to manage use of the ingress buffers 224. The buffer manager performs, for example, one of or any suitable combination of the following: allocates and deallocates specific segments of memory for buffers, creates and deletes buffers within that memory, identifies available buffer entries in which to store a data unit, maintains a mapping of buffers entries to data units stored in those buffers entries (e.g., by a packet sequence number assigned to each packet when the first the first data unit in that packet was received), marks a buffer entry as available when a data unit stored in that buffer is dropped, sent, or released from the buffer, determines when a data unit is to be dropped because it cannot be stored in a buffer, performs garbage collection on buffer entries for data units (or portions thereof) that are no longer needed, etc., in various embodiments.

The buffer manager includes buffer assignment logic (not shown) that is configured to identify which buffer, among multiple buffers in the ingress buffer memory 224, should be utilized to store a given data unit, or portion thereof, according to an embodiment. In some embodiments, each packet is stored in a single entry within its assigned buffer. In yet other embodiments, a packet is received as, or divided into, constituent data units such as fixed-size cells or frames, and the constituent data units are stored separately (e.g., not in the same location, or even the same buffer).

In some embodiments, the buffer assignment logic is configured to assign data units to buffers pseudorandomly, using a round-robin approach, etc. In some embodiments, the buffer assignment logic is configured to assign data units to buffers at least partially based on characteristics of those data units, such as corresponding traffic flows, destination addresses, source addresses, ingress ports, and/or other metadata. For example, different buffers or sets of buffers are utilized to store data units received from different ports 208/212 or sets of ports 208,212. In an embodiment, the buffer assignment logic also or instead utilizes buffer state information, such as utilization metrics, to determine to which buffer a data unit is to be assigned. Other assignment considerations include buffer assignment rules (e.g., no writing two consecutive constituent parts of a same packet to the same buffer) and I/O scheduling conflicts (e.g., to avoid assigning a data unit to a buffer when there are no available write operations to that buffer on account of other components currently reading content from the buffer).

The arbitration circuitry 220 is also configured to maintain ingress queues 228, according to some embodiments, which are used to manage the order in which data units are processed from the buffers in the ingress buffer memory 224. Each data unit, or the buffer locations(s) in which the data unit is stored, is said to belong to one or more constructs referred to as queues. Typically, a queue is a set of memory locations (e.g., in the ingress buffer memory 224) arranged in some order by metadata describing the queue. The memory locations may (and often are) non-contiguous relative to their addressing scheme and/or physical or logical arrangement.

In some embodiments, the sequence of constituent data units as arranged in a queue generally corresponds to an order in which the data units or data unit portions in the queue will be released and processed. Such queues are known as first-in-first-out (“FIFO”) queues, though in other embodiments other types of queues may be utilized. In some embodiments, the number of data units or data unit portions assigned to a given queue at a given time may be limited, either globally or on a per-queue basis, and this limit may change over time.

The ingress portion 204-xa also includes an ingress packet processor 232 that is configured to perform ingress processing operations for packets such as one of, or any suitable combination of two or more of: packet classification, tunnel termination, L2 forwarding lookups, L3 forwarding lookups, etc., according to various embodiments. For example, the ingress packet processor 232 includes an L2 forwarding database and/or an L3 forwarding database, and the ingress packet processor 232 performs L2 forwarding lookups and/or L3 forwarding lookups to determine target ports for packets. In some embodiments, the ingress packet processor 232 uses header information in packets to perform L2 forwarding lookups and/or L3 forwarding lookups.

The ingress arbitration circuitry 220 is configured to release a certain number of data units (or portions of data units) from ingress queues 228 for processing (e.g., by the ingress packet processor 232) or for transfer (e.g., via the interconnect 216) each clock cycle or other defined period of time. The next data unit (or portion of a data unit) to release may be identified using one or more ingress queues 228. For instance, respective ingress ports 208 (or respective groups of ingress ports 208) are assigned to respective ingress queues 228, and the ingress arbitration circuitry 220 selects queues 228 from which to release one or more data units (or portions of data units) according to a selection scheme, such as a round-robin scheme or another suitable selection scheme, in some embodiments. Additionally, when ingress queues 228 are FIFO queues, the ingress arbitration circuitry 220 selects a data unit (or a portion of a data unit) from a head of a FIFO ingress queue 228, which corresponds to a data unit (or portion of a data unit) that has been in the FIFO ingress queue 228 for a longest time, in some embodiments.

In various embodiments, any of various suitable techniques are utilized to identify a particular ingress queues 228 from which to release a data unit (or a portion of a data unit) at a given time. For example, as discussed above, the ingress arbitration circuitry 220 retrieves data units (or portions of data units) from the multiple ingress queues 228 in a round-robin manner, in some embodiments. As other examples, the ingress arbitration circuitry 220 selects ingress queues 228 from which to retrieve data units (or portions of data units) using a pseudo-random approach, a probabilistic approach, etc., according to some embodiments.

Yet other queue selection mechanisms are also possible. The techniques described herein are not specific to any one of these mechanisms, unless otherwise stated.

In some embodiments, ingress queues 228 correspond to specific groups of related traffic, also referred to as priority sets or classes of service. For instance, all packets carrying VoIP traffic are assigned to a first ingress queue 228, while all data units carrying Storage Area Network (“SAN”) traffic are assigned to a different second ingress queue 228. As another example, each of these queues 228 are weighted differently, so as to prioritize certain types of traffic over other traffic, in some embodiments. Moreover, different ingress queues 228 correspond to specific combinations of ingress ports 208 and priority sets, in some embodiments. For example, a respective set of multiple queues 228 correspond to each of at least some of the ingress ports 208, with respective queues 228 in the set of multiple queues 228 corresponding to respective priority sets.

Generally, when the ingress portion 204-xa is finished processing packets, the packets are transferred to one or more egress portions 204-xb via the interconnect 216. Transferring a data unit from an ingress portion 204-xa to an egress portions 204-xb comprises releasing (or dequeuing) the data unit and transferring the data unit to the egress portion 204-xb via the interconnect 216, according to an embodiment.

The ingress arbitration circuitry 220 includes flow control circuitry 236 that is configured to selectively pause the transfer of packets from the ingress queues 228 to the egress portions 204-xb and to selectively resume the transfer of packets from the ingress queues 228 to the egress portions 204-xb in response to flow control messages from the egress portions 204-xb. For example, in response to a first flow control message from an egress portion 204-xb that indicates the egress portion 204-xb is experiencing congestion, the flow control circuitry 236 pauses the transfer of packets to the egress portion 204-xb; in response to a second flow control message from the egress portion 204-xb that indicates the egress portion 204-xb is no longer experiencing congestion, the flow control circuitry 236 resumes the transfer of packets to the egress portion 204-xb, according to an embodiment.

The egress portion 204-xb comprises circuitry 248 (sometimes referred to herein as “traffic manager circuitry 248”) that is configured to control the flow of data units from the ingress portions 204-xa to one or more other components of the egress portion 204-xb. The egress portion 204-xb is coupled to an egress buffer memory 252 that is configured to store egress buffers. A buffer manager (not shown) within the traffic manager circuitry 248 temporarily stores data units received from one or more ingress portions 204-xa in egress buffers as they await processing by one or more other components of the egress portion 204-xb. The buffer manager of the traffic manager circuitry 248 is configured to operate in a manner similar to the buffer manager of the ingress arbiter 220 discussed above.

The egress buffer memory 252 (and buffers of the egress buffer memory 252) is structured the same as or similar to the ingress buffer memory 224 (and buffers of the ingress buffer memory 224) discussed above. For example, each data unit received by the egress portion 204-xb is stored in one or more entries within one or more buffers, which entries are marked as utilized to prevent newly received data units from overwriting data units that are already buffered in the egress buffer memory 252. After a data unit is released to from the egress buffer memory 252, the one or more entries in which the data unit is buffered in the egress buffer memory 252 are then marked as available for storing newly received data units, in some embodiments.

Generally, buffers in the egress buffer memory 252 comprises a variety of buffers or sets of buffers, each utilized for varying purposes and/or components within the egress portion 204-xb.

The buffer manager (not shown) is configured to manage use of the egress buffers 252. The buffer manager performs, for example, one of or any suitable combination of the following: allocates and deallocates specific segments of memory for buffers, creates and deletes buffers within that memory, identifies available buffer entries in which to store a data unit, maintains a mapping of buffers entries to data units stored in those buffers entries (e.g., by a packet sequence number assigned to each packet when the first the first data unit in that packet was received), marks a buffer entry as available when a data unit stored in that buffer is dropped, sent, or released from the buffer, determines when a data unit is to be dropped because it cannot be stored in a buffer, performs garbage collection on buffer entries for data units (or portions thereof) that are no longer needed, etc., in various embodiments.

The traffic manager circuitry 248 is also configured to maintain egress queues 256, according to some embodiments, that are used to manage the order in which data units are processed from the egress buffers 252. The egress queues 256 are structured the same as or similar to the ingress queues 228 discussed above.

In an embodiment, different egress queues 256 may exist for different destinations. For example, each port 212 is associated with a respective set of one or more egress queues 256. The egress queue 256 to which a data unit is assigned may, for instance, be selected based on forwarding information indicating the target port determined for the packet should.

In some embodiments, different egress queues 256 correspond to respective flows or sets of flows. That is, packets for each identifiable traffic flow or group of traffic flows is assigned a respective set of one or more egress queues 256. In some embodiments, different egress queues 256 correspond to different classes of traffic, QoS levels, etc.

In some embodiments, egress queues 256 correspond to respective egress ports 212 and/or respective priority sets. For example, a respective set of multiple queues 256 corresponds to each of at least some of the egress ports 212, with respective queues 256 in the set of multiple queues 256 corresponding to respective priority sets.

Generally, when the egress portion 204-xb receives packets from ingress portions 204-xa via the interconnect 116, the traffic manager circuitry 248 stores (or “enqueues”) the packets in egress queues 256.

The ingress buffer memory 224 corresponds to a same or different physical memory as the egress buffer memory 252, in various embodiments. In some embodiments in which the ingress buffer memory 224 and the egress buffer memory 252 correspond to a same physical memory, ingress buffers 224 and egress buffers 252 are stored in different portions of the same physical memory, allocated to ingress and egress operations, respectively.

In some embodiments in which the ingress buffer memory 224 and the egress buffer memory 252 correspond to a same physical memory, ingress buffers 224 and egress buffers 252 include at least some of the same physical buffers, and are separated only from a logical perspective. In such an embodiment, metadata or internal markings may indicate whether a given individual buffer entry belongs to an ingress buffer 224 or egress buffer 252. To avoid contention when distinguished only in a logical sense, ingress buffers 224 and egress buffers 252 may be allotted a certain number of entries in each of the physical buffers that they share, and the number of entries allotted to a given logical buffer is said to be the size of that logical buffer. In some such embodiments, when a packet is transferred from the ingress portion 204-xa to the egress portion 204-xb within a same packet processing module 204, instead of copying the packet from an ingress buffer entry to an egress buffer, the data unit remains in the same buffer entry, and the designation of the buffer entry (e.g., as belonging to an ingress queue versus an egress queue) changes with the stage of processing.

The egress portion 204-xb also includes an egress packet processor 268 that is configured to perform egress processing operations for packets such as one of, or any suitable combination of two or more of: packet duplication (e.g., for multicast packets), header alteration, rate limiting, traffic shaping, egress policing, flow control, maintaining statistics regarding packets, etc., according to various embodiments. As an example, when a header of a packet is to be modified (e.g., to change a destination address, add a tunneling header, remove a tunneling header, etc.) the egress packet processor 268 modifies header information in the egress buffers 252, in some embodiments.

In an embodiment, the egress packet processor 268 is coupled to a group of egress ports 212 via egress arbitration circuitry 272 that is configured to regulate access to the group of egress ports 212 by the egress packet processor 268.

In some embodiments, the egress packet processor 268 is additionally or alternatively coupled to suitable destinations for packets other than egress ports 212, such as one or more internal central processing units (not shown), one or more storage subsystems, etc.

Many communication protocols tolerate some degree of data loss along the path from sender to recipient (e.g., by the message recipient or an intermediary ignoring dropped data units and/or requesting that those dropped data units be resent). However, in certain protocols or contexts, it is important to minimize or altogether avoid data loss. For example, “lossless” (also referred to as “zero-loss”) protocols are often used to provide constant, uninterrupted communications at lower network levels in support of certain mission critical network-based applications. Examples of such applications include without limitation, Remote Direct Memory Access (“RDMA”) and Fiber Channel over Ethernet (“FCoE”), both often used in data centers.

Systems supporting lossless protocols are generally configured to ensure that any data units in a lossless data stream that arrive at the system are not dropped. Of course, there are physical limitations on the amount of lossless communication a given system may support. Thus, though such protocols are referred to as “lossless,” it will be recognized that at least some of these protocols may include provisions for handling at least some data loss.

Data Center Bridging (“DCB”) is an example of a family of network protocols intended to provide lossless communications. DCB is more particularly aimed at the Ethernet or link layer. DCB includes Data Center Ethernet (“DCE”) and Converged Enhanced Ethernet (“CEE”). CEE includes, in addition to PFC, Enhanced Transmission Selection (“ETS”) (IEEE 802.1Qaz), which provides a common management framework for assignment of bandwidth to frame priorities, and Congestion Notification (IEEE 802.1Qau), which provides end to end congestion management for protocols that are capable of limiting transmission rate to avoid frame loss.

Of course, a variety of other lossless protocols and mechanisms exist, and the techniques described herein are not particular to any specific lossless protocol unless otherwise stated. Moreover, certain techniques described herein may also provide advantages in systems and/or with traffic that do not support lossless communications, though additional benefits may be realized with lossless communications.

The traffic manager circuitry 248 comprises adaptive backpressure circuitry 280. The adaptive backpressure circuitry 280 is configured to determine when one or more measures indicate congestion related to the egress buffer memory 252. In some embodiments, the adaptive backpressure circuitry 280 is configured to generate measures that indicate congestion related to the egress buffer memory 252 due to packet data from respective ingress sources, such as respective ingress ports 208, respective ingress port 208—priority set pairs, etc.

For example, adaptive backpressure circuitry 280 determines when an amount of memory space in the egress buffer memory 252 that stores packet data from a particular ingress source (e.g., a particular ingress port 208, a particular ingress port 208—priority set pair, etc.) indicates congestion of the egress buffer memory 252 related to that ingress source, in an embodiment. For example, the adaptive backpressure circuitry 280 is configured to compare the amount of memory space utilized for packet data from the ingress source to a threshold. The threshold may be global for all ingress sources, different for different types of ingress sources, or different even among the same type of ingress source. In some embodiments, thresholds are programmable, reconfigurable, and/or dynamically adjusted.

When the amount of space utilized for packet data from the ingress source is above the threshold, the adaptive backpressure circuitry 280 determines that the egress buffer memory 252 is congested with regard to packet data from the ingress source, in an embodiment. When the amount of space utilized for packet data from the ingress source falls below the threshold, the adaptive backpressure circuitry 280 determines that the egress buffer memory 252 is not congested with regard to packet data from the ingress source. In an embodiment, the adaptive backpressure circuitry 280 is configured to use different thresholds depending on a congestion state of the egress buffer memory 252. For example, when the egress buffer memory 252 is in a not congested state with regard to packet data from the ingress source the adaptive backpressure circuitry 280 compares the amount of space utilized for packet data from the ingress source to a first threshold to determine whether the egress buffer memory 252 has transitioned to a congested state; and when the egress buffer memory 252 is in the congested state the adaptive backpressure circuitry 280 compares the amount of space utilized for packet data from the ingress source to a second threshold to determine whether the egress buffer memory 252 has transitioned to the not congested state with regard to packet data from the ingress source, where the second threshold is lower than the first threshold.

The adaptive backpressure circuitry 280 compares an indication of an amount of space being utilized to the appropriate threshold whenever it is necessary to determine whether there is congestion, in an embodiment. In other embodiments, the adaptive backpressure circuitry 280 is configured to perform comparisons at some frequency (e.g., every other clock cycle, whenever the count information is updated, etc.) and to determine the resulting states (e.g., congested or not congested).

In other embodiments, the adaptive backpressure circuitry 280 additionally or alternatively is configured to compare input rates and output rates to determine when the egress buffer memory 252 is in a congested state with regard to packet data from the ingress source. For instance, the adaptive backpressure circuitry 280 determines an amount of data units received at the traffic manager circuitry 248 from the particular ingress source during a particular duration of time, and further measures the number of data units from the ingress source that the traffic manager circuitry 248 releases from the egress buffer memory 252 during that particular duration of time. When the number of data units received over that particular duration of time exceeds the number of data units released by more than a threshold amount, the entity is determined to be in a congested state, in an embodiment.

As another example, the adaptive backpressure circuitry 280 additionally or alternatively is configured to determine a rate of change of a difference between an input rate and an output rate with regard to an ingress source, and to use the rate of change to determine when the egress buffer memory 252 is in a congested state with regard to packet data from the ingress source, in an embodiment.

In other embodiments, other suitable techniques are additionally or alternatively used to determine when the egress buffer memory 252 is in a congested state with regard to packet data from an ingress source, and the techniques described herein are not limited to a specific mechanism for detecting congestion unless otherwise stated. Moreover, it will be noted that different congestion thresholds and states may exist for different purposes.

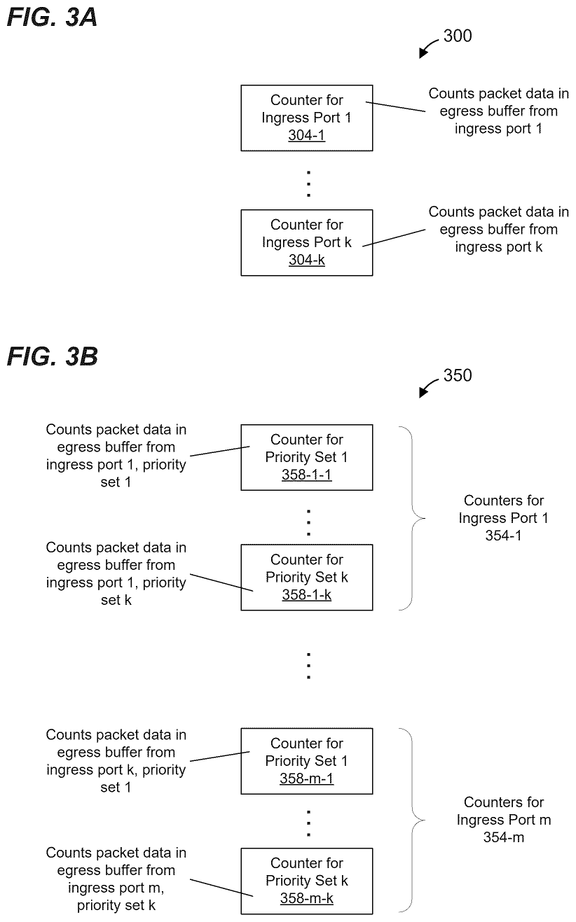

FIG. 3A is a simplified block diagram of a set 300 of counters maintained by the adaptive backpressure circuitry 280 for the egress buffer memory 252, according to an embodiment. The adaptive backpressure circuitry 280 uses the set 300 of counters to determine congestion of the egress buffer memory 252 due to respective ingress ports 208, in an embodiment. In other embodiments, the adaptive backpressure circuitry 280 does not include counters such as the set 300 of counters, but rather determines congestion of the egress buffer memory 252 due to respective ingress ports 208 using another suitable mechanism.

The set 300 of counters includes a respective counter 304 for each of multiple ingress ports 208. In connection with the adaptive backpressure circuitry 280 determining that a data unit has been enqueued in the egress buffer memory 252, the adaptive backpressure circuitry 280 determines the ingress port 208 from which the data unit was received and then increments the corresponding counter 304. Additionally, in connection with the adaptive backpressure circuitry 280 determining that a data unit has been dequeued from the egress buffer memory 252, the adaptive backpressure circuitry 280 determines the ingress port 208 from which the data unit was received and then decrements the corresponding counter 304.

FIG. 3B is a simplified block diagram of a set 350 of counters maintained by the adaptive backpressure circuitry 280 for the egress buffer memory 252, according to another embodiment. The adaptive backpressure circuitry 280 uses the set 350 of counters to determine congestion of the egress buffer memory 252 due to respective ingress port 208/priority set pairs, in an embodiment. In other embodiments, the adaptive backpressure circuitry 280 does not include counters such as the set 350 of counters, but rather determines congestion of the egress buffer memory 252 due to respective ingress port 208/priority set pairs using another suitable mechanism.

The set 350 of counters includes a respective subset 354 of one or more counters for each of multiple ingress ports 208. Each subset 354 includes one or more counters 358 corresponding to one or more respective priority sets. In connection with the adaptive backpressure circuitry 280 determining that a data unit has been enqueued in the egress buffer memory 252, the adaptive backpressure circuitry 280 determines the ingress port 208 from which the data unit was received and the priority set to which the data unit corresponds; and the adaptive backpressure circuitry 280 then increments the corresponding counter 358. Additionally, in connection with the adaptive backpressure circuitry 280 determining that a data unit has been dequeued from the egress buffer memory 252, the adaptive backpressure circuitry 280 determines the ingress port 208 from which the data unit was received and the priority set to which the data unit corresponds; and the adaptive backpressure circuitry 280 then decrements the corresponding counter 358.

Although FIG. 3B illustrates each subset 354 as including k counters 358, in other embodiments each subset 354 need not include a same number of counters 358.

In some embodiments, the adaptive backpressure circuitry 280 is reconfigurable to use counters, such as the counters 304 and 358 of FIGS. 3A-B, in different ways, such as to count as illustrated in FIG. 3A and to count as illustrated in FIG. 3B, or some other suitable manner.

Referring again to FIG. 2A, the adaptive backpressure circuitry 280 is configured to: in response to determining a congested state due to an ingress source, send a first flow control message to an ingress portion 204-xa corresponding to the ingress source. The first flow control message (sometimes referred to herein as a “congestion” message) indicates to the ingress portion 204-xa that the ingress portion 204-xa should pause sending, to the egress portion 204-xb, data units from the ingress source. In some embodiments, each congestion message indicates an ingress port 208 from which the ingress portion 204-xa should pause sending data unit to the egress portion 204-xb. In some embodiments, each congestion message also indicates a priority set, from which the ingress portion 204-xa should pause sending data units to the egress portion 204-xb. In some embodiments, each congestion message indicates an ingress queue 228 from which the ingress portion 204-xa should pause sending packets to the egress portion 204-xb. For example, the ingress queue 228 corresponds to an ingress port 208/priority set pair from which the ingress portion 204-xa should pause sending packets.

In an embodiment, the adaptive backpressure circuitry sends the congestion message to the ingress portion 204-xa that corresponds to the ingress source. In other embodiments, the adaptive backpressure circuitry sends the congestion message to all ingress portions 204-xa. In other embodiments, the adaptive backpressure circuitry sends the congestion message to a subset of the ingress portions 204-xa, such as to one or more ingress portions 204-xa that the adaptive backpressure circuitry 280 determines are sending data units to the egress buffer memory 252.

The adaptive backpressure circuitry 280 is configured to: in response to determining that the egress buffer memory 252 is no longer in the congested state due to the ingress source (i.e., has transitioned from the congested state to the not congested state with regard to the ingress source), send a second flow control message to the ingress portion 204-xa corresponding to the ingress source. The second flow control message (sometimes referred to herein as an “no congestion” message) indicates to the ingress portion 204-xa that the ingress portion 204-xa should resume sending, to the egress portion 204-xb, data units from the ingress source.

In some embodiments, each no congestion message indicates an ingress port 208 from which the ingress portion 204-xa should resume sending packets to the egress portion 204-xb. In some embodiments, each no congestion message also indicates a priority set of which the ingress portion 204-xa should resume sending packets to the egress portion 204-xb. In some embodiments, each no congestion message indicates an ingress queue 228 from which the ingress portion 204-xa should resume sending packets to the egress portion 204-xb. For example, the ingress queue 228 corresponds to an ingress port 208/priority set pair from which the ingress portion 204-xa should resume sending packets.

In an embodiment, the adaptive backpressure circuitry sends the no congestion message to the ingress portion 204-xa that corresponds to the ingress source. In other embodiments, the adaptive backpressure circuitry sends the no congestion message to all ingress portions 204-xa. In other embodiments, the adaptive backpressure circuitry sends the no congestion message to a subset of the ingress portions 204-xa, such as to one or more ingress portions 204-xa to which the adaptive backpressure circuitry 280 previously sent the congestion message, to one or more ingress portions 204-xa that the adaptive backpressure circuitry 280 determines are/were sending data units to the egress buffer memory 252, etc.

Referring again to the flow control circuitry 236 of the ingress portion 204-xa, the flow control circuitry 236 is configured to: in response to receiving the first flow control message (congestion message) from one of the adaptive backpressure circuitry 280, pause sending data units corresponding to the ingress source identified in the first flow control message. In an embodiment, the flow control circuitry 236 is configured to: in response to receiving the first flow control message (congestion message) from one of the adaptive backpressure circuitry 280, pause sending data units corresponding to the ingress source to the egress portion 204-xb that sent the congestion message.

Additionally, the flow control circuitry 236 is configured to: in response to receiving the second flow control message (no congestion message) from one of the adaptive backpressure circuitry 280, resume sending data units from the ingress source. In an embodiment, the flow control circuitry 236 is configured to: in response to receiving the second flow control message (no congestion message) from one of the adaptive backpressure circuitry 280, resume sending data units from the ingress source to the egress portion 204-xb that sent the no congestion message.

In some embodiments, the flow control circuitry 236 uses information in a congestion message to determine an ingress queue 228 from which to pause sending packet data. For example, in some embodiments in which the congestion message includes an indication of an ingress port 208/priority set pair, the flow control circuitry 236 uses the indication of the ingress port 208/priority set pair to determine that sending data units from an ingress queue 228 that corresponds to the ingress port 208/priority set pair to the egress portion 204-xb is to be paused. As another example, in some embodiments in which the congestion message includes an indication of an ingress port 208, the flow control circuitry 236 uses the indication of the ingress port 208 to determine that sending data units from an ingress queue 228 corresponding to the ingress port 208 to the egress portion 204-xb is to be paused. As another example, in some embodiments in which the congestion message includes an indication of the ingress queue 228, the flow control circuitry 236 uses the indication of the ingress queue 228 to determine that sending data units from the ingress queue 228 to the egress portion 204-xb is to be paused.

Similarly, in some embodiments, the flow control circuitry 236 uses information in a no congestion message to determine an ingress queue 228 from which to resume sending packet data. For example, in some embodiments in which the no congestion message includes an indication of an ingress port 208/priority set pair, the flow control circuitry 236 uses the indication of the ingress port 208/priority set pair to determine that sending data units from an ingress queue 228 that corresponds to the ingress port 208/priority set pair to the egress portion 204-xb is to be resumed. As another example, in some embodiments in which the congestion message includes an indication of an ingress port 208, the flow control circuitry 236 uses the indication of the ingress port 208 to determine that sending data units from an ingress queue 228 corresponding to the ingress port 208 to the egress portion 204-xb is to be resumed. As another example, in some embodiments in which the no congestion message includes an indication of the ingress queue 228, the flow control circuitry 236 uses the indication of the ingress queue 228 to determine that sending data units from the ingress queue 228 is to be resumed.

FIG. 2B is a simplified block diagram of an example adaptive backpressure circuitry 280 of FIG. 2A, according to an embodiment. In other embodiments, the adaptive backpressure circuitry 280 of FIG. 2A has another suitable structure different than the structure illustrated in FIG. 2B. In some embodiments, the adaptive backpressure circuitry 280 of FIG. 2B is included in another suitable network device different than the example network device 200 of FIG. 2A.

Congestion detection circuitry 284 is configured to monitor a corresponding buffer memory (e.g., a corresponding buffer memory 252) to detect congestion corresponding to data units received from a plurality of sources. For example, the congestion detection circuitry 284 monitors an egress buffer memory 252 to detect congestion corresponding to data units received from a plurality of ingress queues 228, a plurality of input port/priority set tuples, etc., and to determine when the congestion has ended, according to some embodiments.

In response to detecting congestion corresponding to a particular source (e.g., a particular ingress queue 228, a particular ingress port/priority set tuple, etc.), the congestion detection circuitry 284 generates a first output that indicates the particular source that is contributing to congestion, according to an embodiment. In response to detecting an end of congestion corresponding to the particular source (e.g., the particular ingress queue 228, the particular ingress port/priority set tuple, etc.), the congestion detection circuitry 284 generates a second output that indicates the congestion due to the particular source has ended, according to an embodiment.

The congestion detection circuitry 284 is configured to detect congestion corresponding to a particular source using techniques such as described herein, or using other suitable techniques, according to various embodiments. The congestion detection circuitry 284 is configured to detect an end of congestion corresponding to the particular source using techniques such as described herein, or using other suitable techniques, according to various embodiments.

Congestion message generation circuitry 288 is configured to receive first outputs generated by the congestion detection circuitry 284 and, in response, generate congestion messages such as described herein, or other suitable congestion messages. In some embodiments, each congestion message indicates a particular source (e.g., a particular ingress queue 228, a particular ingress port/priority set tuple, etc.) that is causing congestion.

No congestion message generation circuitry 290 is configured to receive second outputs generated by the congestion detection circuitry 284 and, in response, generate no congestion messages such as described herein, or other suitable no congestion messages. In some embodiments, each no congestion message indicates the particular source (e.g., the particular ingress queue 228, the particular ingress port/priority set tuple, etc.) that is permitted to resume sending packet data to the egress buffer.

Limiting circuitry 294 is configured to limit a number of no congestion messages that are sent by the adaptive backpressure circuitry 280 during respective time periods, in an embodiment. This has the effect of limiting the number of ingress portions 204-xa that resume transferring packet data during each of multiple time periods after the congestion condition has ended, and in this way the amount of packet data being transferred to egress buffer can be stepwise increased, which may help improve efficient use of the egress buffer memories 252, at least in some embodiments. In an embodiment, the limiting circuitry 294 limits a quantity of the no congestion messages that are sent to the multiple sources during a time period to a maximum quantity such that one or more no congestion messages are sent to a first subset of sources among the multiple sources during the time period and zero no congestion messages are sent to a second subset of sources among the multiple sources during the time period. For example, the limiting circuitry 294 limits the quantity of the no congestion messages that are sent to the one or more ingress arbiters 220 during the time period.

FIG. 2C is timing diagram 296 illustrating an example operation of the adaptive backpressure circuitry 280 of FIG. 2B, according to an embodiment. At a time T1, the congestion detection circuitry 284 begins detecting congestion of the egress buffer memory 252 due to ten sources (e.g., particular ingress queues 228, particular ingress port/priority set tuples, etc.). In response to detecting congestion, the congestion message generation circuitry 288 generates ten congestion messages, and the adaptive backpressure circuitry 280 sends the ten congestion messages to prompt the ten sources to pause transferring packet data to the egress buffer memory 252.

At a time T2, the congestion detection circuitry 284 begins detecting congestion of the egress buffer memory 252 due to the ten sources has ended. In response to detecting congestion has ended, the no congestion message generation circuitry 288 generates ten no congestion messages. The limiting circuitry 294 limits the number of no congestion messages that are sent by the adaptive backpressure circuitry 280 during each of multiple time periods 298. For example, during a time period 298-1, the limiting circuitry 294 permits the adaptive backpressure circuitry 280 to send four no congestion messages corresponding to four of the sources; during a time period 298-2, the limiting circuitry 294 permits the adaptive backpressure circuitry 280 to send another four no congestion messages corresponding to another four of the sources; and during a time period 298-3, the limiting circuitry 294 permits the adaptive backpressure circuitry 280 to send the remaining two no congestion messages corresponding to the remaining two of the sources, according to an embodiment.

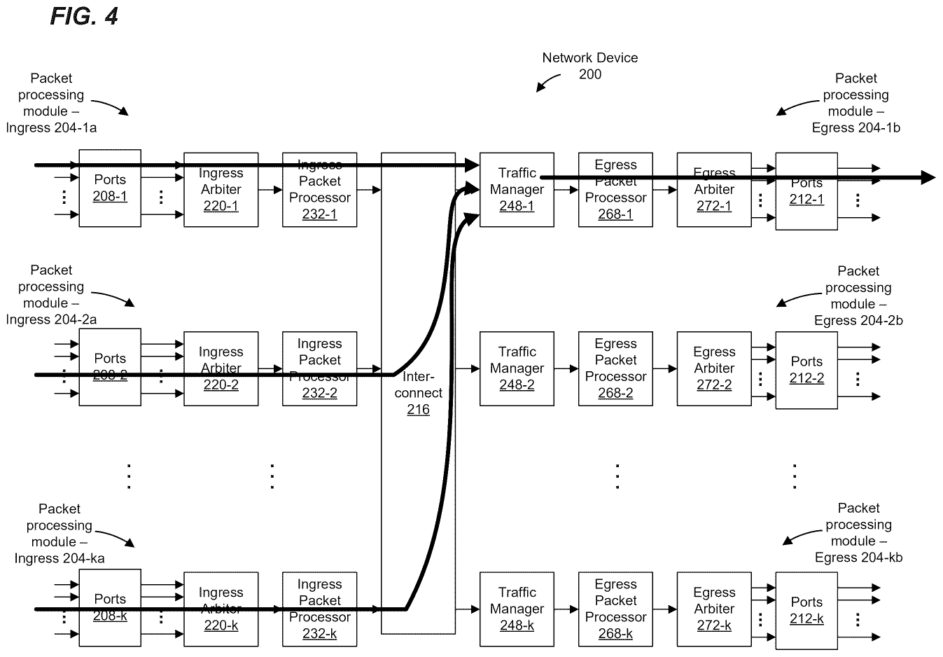

FIG. 4 is a simplified block diagram of the network device 200 of FIG. 2A showing flows of packets corresponding to a single entity, such as a particular egress port 212, a particular egress buffer 252, a particular egress queue 256, a particular set of egress queues 256, etc., according to an embodiment. For example, dark arrows in FIG. 4 show flows of packets corresponding to the single entity through multiple ingress portions 204-xa, the interconnect 216, and the egress portion 204-1b.

In the example illustrated in FIG. 4, packets that eventually are transmitted via a single egress port 212 are received at multiple ingress portions 204-xa. These packets are transferred through the interconnect 216 to the egress portion 204-1b, and eventually transmitted by the single egress port 212.

When adaptive backpressure circuitry 280-1 in the egress portion 204-1b determines that an entity corresponding to the single egress port 212 (e.g., the port 212, an egress buffer 252, an egress queue 256, etc.) has become congested, the adaptive backpressure circuitry 280-1 sends one or more first flow control messages (e.g., congestion messages) to the multiple ingress portions 204-xa. In response to the multiple ingress portions 204-xa receiving the first flow control messages, the multiple ingress portions 204-xa pause sending data units corresponding to the entity to the egress portion 204-1b.

When the adaptive backpressure circuitry 280-1 in the egress portion 204-1b later determines that the entity corresponding to the single egress port 212 (e.g., the port 212, an egress buffer 252, an egress queue 256, a transmit queue, etc.) is no longer congested, the adaptive backpressure circuitry 280-1 sends second flow control messages (e.g., no congestion messages) to the multiple ingress portions 204-xa. In response to the multiple ingress portions 204-xa receiving the second flow control messages, the multiple ingress portions 204-xa resume sending data units corresponding to the entity to the egress portion 204-1b.

To improve efficient use of the egress buffer memories 252, the adaptive backpressure circuitry 280 of the egress portion 204-xb is configured to limit a quantity of second flow control messages (e.g., no congestion messages) for an entity corresponding to a single egress port 212 (e.g., the port 212, an egress buffer 252, an egress queue 256, etc.) that the adaptive backpressure circuitry 280 sends to the ingress portions 204-xa during a time period. This has the effect of limiting the number of ingress portions 204-xa that resume transferring packet data during each of multiple time periods after the congestion condition has ended, and in this way the amount of packet data being transferred to entity in the egress portion 204-xb can be stepwise increased, which may help improve efficient use of the egress buffer memories 252, at least in some embodiments. As an illustrative example, if 50 source ports 208 have caused congestion at a particular egress queue 256, the adaptive backpressure circuitry 280 permits only twenty of the 50 source ports 208 to resume transferring data to the egress queue 256 during a particular time period; during a subsequent time period, the adaptive backpressure circuitry 280 permits another twenty of the 50 source ports 208 to resume transferring data to the egress queue 256; and during a further time period, the adaptive backpressure circuitry 280 permits the remaining ten source ports 208 to resume transferring data to the egress queue 256, according to an embodiment.

Thus, the adaptive backpressure circuitry 280 of the egress portion 204-xb is configured to control the number of sources (e.g., ingress port 208/priority set pairs, ingress ports 208, etc.) that can resume transferring packet data to an entity of or corresponding to the egress portions 204-xb during a time period.

In some embodiments, a limit on the number of second flow control messages (e.g., no congestion messages) for the entity that can be transmitted during the time period is determined based on one or more conditions of the network device 200. For example, the limit on the number of second flow control messages (e.g., no congestion messages) for the entity that can be transmitted during the time period is determined based on a quantity of sources (e.g., ingress port 208/priority set pairs, ingress ports 208, etc.) that contributed to the congestion condition of the entity of the egress portion 204-xb, in an embodiment. For instance, the limit when twenty sources contributed to the congestion condition is different than the limit when 100 sources contributed to the congestion condition, in an embodiment.

As another example, the limit on the number of second flow control messages (e.g., no congestion messages) for the entity that can be transmitted during the time period is determined based on an amount of buffer space available in a buffer corresponding to the entity that was in the congestion state. As another example, the limit on the number of second flow control messages (e.g., no congestion messages) for the entity that can be transmitted during the time period is determined based on a number of egress ports 212 that are in the congestion state, according to another embodiment.

As another example, the limit on the number of second flow control messages (e.g., no congestion messages) for the entity that can be transmitted during the time period is determined based on a quantity of egress ports 212 that correspond to an egress buffer in which the egress queue is implemented and that are experiencing congestion, according to another embodiment.

In some embodiments, the limit on the number of second flow control messages (e.g., no congestion messages) for the entity that can be transmitted during the time period is pseudorandomly determined, e.g., within a range of limit values, per each time period. In some embodiments, the range is determined based on one or more conditions of the network device 200, such as conditions described above.

In some embodiments, a duration of each time period during which the limit applies is varied for different time periods. For example, the duration of each time period is pseudorandomly determined, e.g., within a range, such that adjacent time periods are likely to have different durations. In some embodiments, the range is determined based on one or more conditions of the network device 200 such as described above.

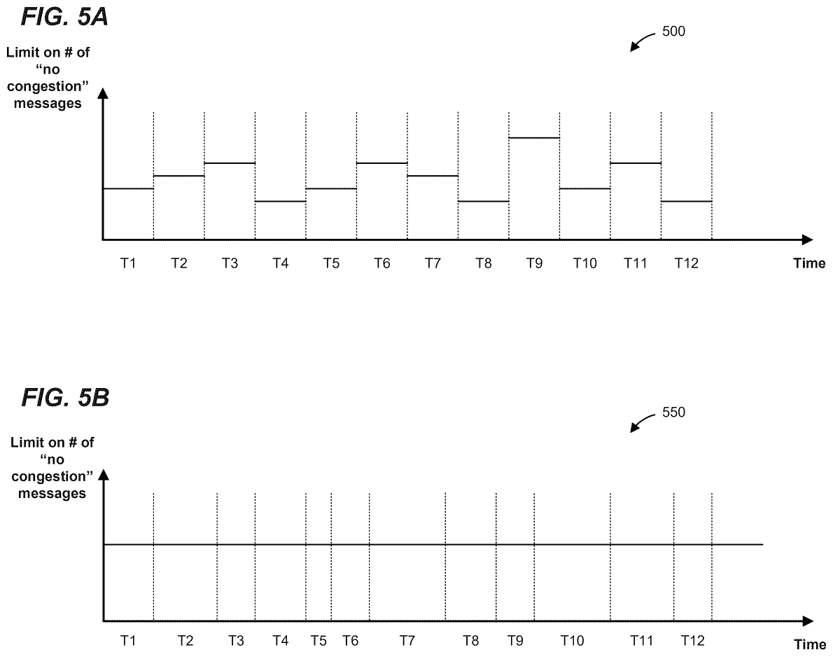

FIG. 5A is a plot 500 illustrating an example of respective limits on the number of second flow control messages (e.g., no congestion messages) for the entity of the egress portion 204-xb that can be transmitted in different time periods T1 through T12, according to an embodiment. The adaptive backpressure circuitry 280 is configured to control the limit in a manner illustrated in the plot 500, in an embodiment.

As illustrated in FIG. 5A, the limit changes over time and is potentially different in each of the different time periods T1 through T12.

In other embodiments, the limit remains the same for a set of two or more consecutive time periods, but can be changed as described above in different sets of two or more consecutive time periods.

FIG. 5A is a plot 500 illustrating an example of respective limits on the number of second flow control messages (e.g., no congestion messages) for the entity of the egress portion 204-xb that can be transmitted in different time periods T1 through T12, according to an embodiment. The adaptive backpressure circuitry 280 is configured to control the number of second flow control messages (e.g., no congestion messages) for the entity that can be transmitted in each of the different time periods T1 through T12 in a manner corresponding to the plot 500, in an embodiment.

As illustrated in FIG. 5A, the limit changes over time and is potentially different in each of the different time periods T1 through T12.

In other embodiments, the limit remains the same for a set of two or more consecutive time periods, but can be changed as described above in different sets of two or more consecutive time periods.

FIG. 5B is a plot 550 illustrating an example of a limit on the number of second flow control messages (e.g., no congestion messages) for the entity of the egress portion 204-xb that can be transmitted in different time periods T1 through T12, according to another embodiment. The adaptive backpressure circuitry 280 is configured to control the number of second flow control messages (e.g., no congestion messages) for the entity that can be transmitted in each of the different time periods T1 through T12 in a manner corresponding to the plot 550, in an embodiment.

As illustrated in FIG. 5B, the limit remains the same over time, but a duration of each of the different time periods T1 through T12 may be different.

In other embodiments, a duration of a time period remains the same for a set of two or more consecutive time periods, but can be changed as described above in different sets of two or more consecutive time periods.

In some embodiments, the limit can vary in each set of one or more time periods and a duration of each time period in the set of one or more time periods can vary.

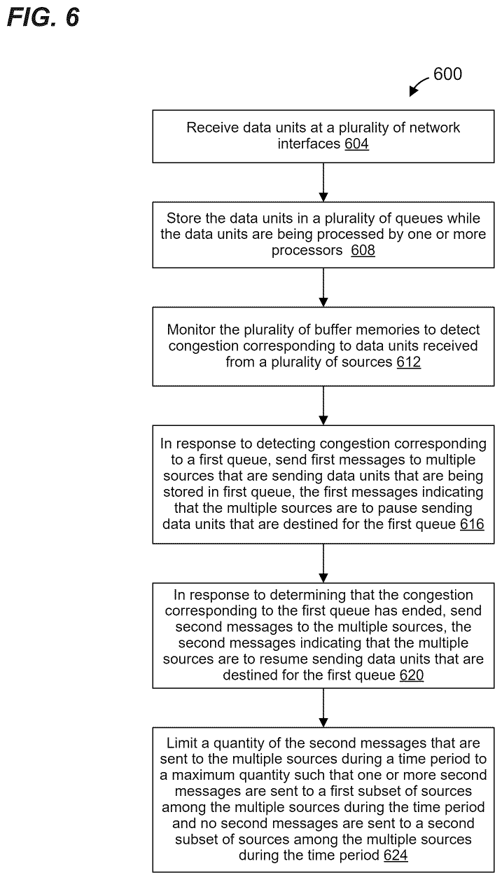

FIG. 6 is a flow diagram of an example method 600 for processing data units in a network device, according to an embodiment. The method 600 is implemented in a network device that includes a plurality of network interfaces; one or more packet processors configured to process data units received via the plurality of network interfaces; and a plurality of buffer memories; in some embodiments. In an embodiment, the method 600 is implemented by the network device 200 of FIG. 2A, and FIG. 6 is described with reference to FIG. 2A for explanatory purposes. In other embodiments, the method 600 is implemented by another suitable network device.

At block 604, a network device receives data units at a plurality of network interfaces of the network device. For example, the network device 200 receives data units at the ports 208.

At block 608, the network device stores data units received at the plurality of network interfaces in a plurality of queues while the data units are processed by one or more processors of the network device. In an embodiment, the plurality of queues corresponding to one or more buffer memories. For example, the network device 200 stores data units received at the ports 208 in the egress queues 256 corresponding to the egress buffer memories 252.

At block 612, the network device monitors the plurality of buffer memories to detect congestion corresponding to data units received from a plurality of sources. For example, the traffic manager circuitry 248 monitors the plurality of egress buffer memories 252 to detect congestion corresponding to data units received from a plurality of ingress queues 228.

At block 616, in response to detecting congestion corresponding to a first queue among the plurality of queues, circuitry of the network device sends first messages to multiple sources that are sending data units that are being stored in the queue. The first messages indicate that the multiple sources are to pause sending data units that are destined for the first queue, in an embodiment. For example, the adaptive backpressure circuitry 280 sends congestion messages to one or more ingress arbiters 220, the congestion messages indicating that data transfer from multiple ingress queues 228 to a first egress queue 256 are to be paused.

At block 620, in response to determining that the congestion corresponding to the first queue has ended, the circuitry sends second messages to the multiple sources, the second messages indicating that the multiple sources are to resume sending data units that are destined for the first queue. For example, the adaptive backpressure circuitry 280 sends no congestion messages to one or more ingress arbiters 220, the no congestion messages indicating that data transfer from the multiple ingress queues 228 to the first egress queue 256 is to be resumed.

At block 624, the circuitry limits a quantity of the second messages that are sent to the multiple sources during a time period to a maximum quantity such that one or more second messages are sent to a first subset of sources among the multiple sources during the time period and no second messages are sent to a second subset of sources among the multiple sources during the time period. For example, the adaptive backpressure circuitry 280 limits the quantity of the no congestion messages that are sent to the one or more ingress arbiters 220 during the time period.

In another embodiment, the method 600 further comprises determining, by the network device, the maximum quantity based on a quantity of sources to which the one or more first messages were sent. For example, the adaptive backpressure circuitry 280 determines the maximum quantity based on a quantity of ingress queues 228 to which the one or more congestion messages correspond.

In another embodiment, the method 600 further comprises determining, by the network device, the maximum quantity based on a status of a buffer memory, among the plurality of buffer memories, in which the first queue is implemented. For example, the adaptive backpressure circuitry 280 determines the maximum quantity based on a status of an egress buffer memory 220 to which the first egress queue 256 corresponds.

In another embodiment, the method 600 further comprises determining, by the network device, the maximum quantity based on a quantity of egress ports of the network device that are experiencing congestion. For example, the adaptive backpressure circuitry 280 determines the maximum quantity based on a quantity of egress ports 212 of the network device that are experiencing congestion.

In another embodiment, the method 600 further comprises determining, by the network device, the maximum quantity pseudorandomly. For example, the adaptive backpressure circuitry 280 determines the maximum quantity pseudorandomly.

In another embodiment, the method 600 further comprises determining, by the network device, a duration of the time period pseudorandomly. For example, the adaptive backpressure circuitry 280 determines the duration of the time period pseudorandomly.

In another embodiment, the time period is a first time period, and sending the second messages to the multiple sources comprises sending one or more second messages to one or more sources among the second subset of sources during a second time period that follows the first period.

In another embodiment, the maximum quantity is a first maximum quantity, and the method 600 further comprises: limiting, by the network device, a quantity of the second messages that are sent to the multiple sources during the second time period to a second maximum quantity.

In an embodiment, at least one of i) the first maximum quantity is different than the second maximum quantity, and ii) a first duration of the first time period is different than a second duration of the second time period.

Embodiment 1: A network device, comprising: a plurality of network interfaces; a plurality of packet processors configured to process data units received via the plurality of network interfaces to determine network interfaces, among the plurality of network interfaces, that are to transmit the data units; a plurality of buffer memories; a plurality of queues corresponding to the plurality of buffer memories, the plurality of queues configured to store data units received via the plurality of network interfaces while the data units are being processed by the plurality of packet processors; and first circuitry. The first circuitry is configured to: monitor the plurality of buffer memories to detect congestion corresponding to data units received from a plurality of sources; in response to detecting congestion corresponding to a first queue among the plurality of queues, send first messages to multiple sources that are sending data units that are being stored in the first queue, the first messages indicating that the multiple sources are to pause sending data units that are destined for the first queue; in response to determining that the congestion corresponding to the first queue has ended, send second messages to the multiple sources, the second messages indicating that the multiple sources are to resume sending data units that are destined for the first queue; and limit a quantity of the second messages that are sent to the multiple sources during a time period to a maximum quantity such that one or more second messages are sent to a first subset of sources among the multiple sources during the time period and no second messages are sent to a second subset of sources among the multiple sources during the time period.

Embodiment 2: The network device of embodiment 1, wherein the circuitry is further configured to: determine the maximum quantity based on a quantity of sources to which the one or more first messages were sent.

Embodiment 3: The network device of either of embodiments 1 or 2, wherein the circuitry is further configured to: determine the maximum quantity based on a status of a buffer memory, among the plurality of buffer memories, in which the first queue is implemented.

Embodiment 4: The network device of any of embodiments 1-3, wherein the circuitry is further configured to: determine the maximum quantity based on a quantity of egress ports of the network device that are experiencing congestion.

Embodiment 5: The network device of any of embodiments 1-4, wherein the circuitry is further configured to: determine the maximum quantity pseudorandomly.

Embodiment 6: The network device of any of embodiments 1-5, wherein the circuitry is further configured to: determine a duration of the time period pseudorandomly.

Embodiment 7: The network device of any of embodiments 1-6, wherein the time period is a first time period, and wherein the circuitry is configured to: send one or more second messages to one or more sources among the second subset of sources during a second time period that follows the first period.

Embodiment 8: The network device of embodiment 7, wherein the maximum quantity is a first maximum quantity, and wherein the circuitry is further configured to: limit a quantity of the second messages that are sent to the multiple sources during the second time period to a second maximum quantity.

Embodiment 9: The network device of embodiment 8, wherein at least one of i) the first maximum quantity is different than the second maximum quantity, and ii) a first duration of the first time period is different than a second duration of the second time period.

Embodiment 10: The network device of any of embodiments 1-9, wherein the plurality of queues are a plurality of egress queues, wherein the one or more processors are one or more egress packet processors of the network device, wherein the one or more buffer memories are one or more egress buffer memories, wherein the circuitry is first circuitry, and wherein the network device further comprises: one or more ingress packet processors configured to process data units received via the plurality of network interfaces to determine network interfaces, among the plurality of network interfaces, that are to transmit the data units; and a plurality of ingress queues configured to store data units received via the plurality of network interfaces while the data units are being processed by the one or more ingress packet processors; wherein the one or more egress packet processors are configured to process data units received from the plurality of ingress queues; wherein the one or more egress buffer memories are configured to store data units received from the plurality of ingress queues while the data units are being processed by the one or more egress packet processors, the data units received from the plurality of ingress queues being stored in the plurality of egress queues corresponding to the one or more egress buffer memories. The circuitry is configured to: monitor the plurality of egress buffer memories to detect congestion corresponding to data units received from the plurality of ingress queues; send the first messages to second circuitry associated with the ingress queues; send the second messages to the second circuitry; and limit the quantity of the second messages that are sent to the second circuitry during the time period.

Embodiment 11: A method for processing data units in a network device, the method comprising: receiving data units at a plurality of network interfaces of the network device; storing data units received at the plurality of network interfaces in a plurality of queues while the data units are processed by one or more processors of the network device, the plurality of queues corresponding to one or more buffer memories; monitoring, by the network device, the plurality of buffer memories to detect congestion corresponding to data units received from a plurality of sources; in response to detecting congestion corresponding to a first queue among the plurality of queues, sending, by circuitry of the network device, first messages to multiple sources that are sending data units that are being stored in the first queue, the first messages indicating that the multiple sources are to pause sending data units that are destined for the first queue; in response to determining that the congestion corresponding to the first queue has ended, sending, by the circuitry, second messages to the multiple sources, the second messages indicating that the multiple sources are to resume sending data units that are destined for the first queue; and limiting, by the circuitry, a quantity of the second messages that are sent to the multiple sources during a time period to a maximum quantity such that one or more second messages are sent to a first subset of sources among the multiple sources during the time period and no second messages are sent to a second subset of sources among the multiple sources during the time period.

Embodiment 12: The method of embodiment 11, further comprising: determining, by the network device, the maximum quantity based on a quantity of sources to which the one or more first messages were sent.

Embodiment 13: The method of either of embodiments 11 or 12, further comprising: determining, by the network device, the maximum quantity based on a status of a buffer memory, among the plurality of buffer memories, in which the first queue is implemented.

Embodiment 14: The method of any of embodiments 11-13, further comprising: determining, by the network device, the maximum quantity based on a quantity of egress ports of the network device that are experiencing congestion.

Embodiment 15: The method of any of embodiments 11-14, further comprising: determining, by the network device, the maximum quantity pseudorandomly.

Embodiment 16: The method of any of embodiments 11-15, further comprising: determining, by the network device, a duration of the time period pseudorandomly.

Embodiment 17: The method of any of embodiments 11-16, wherein the time period is a first time period, and wherein sending the second messages to the multiple sources comprises: sending one or more second messages to one or more sources among the second subset of sources during a second time period that follows the first period.

Embodiment 18: The method of embodiment 17, wherein the maximum quantity is a first maximum quantity, and wherein the method further comprises: limiting, by the network device, a quantity of the second messages that are sent to the multiple sources during the second time period to a second maximum quantity.

Embodiment 19: The method of embodiment 18, wherein at least one of i) the first maximum quantity is different than the second maximum quantity, and ii) a first duration of the first time period is different than a second duration of the second time period.

Embodiment 20: The method of any of embodiments 11-19, wherein the plurality of queues are a plurality of egress queues, wherein the one or more processors are one or more egress packet processors of the network device, wherein the one or more buffer memories are one or more egress buffer memories, wherein the circuitry is first circuitry, and wherein the method further comprises: storing data units received at the plurality of network interfaces in a plurality of ingress queues of the network device while the data units are processed by a plurality of ingress packet processors of the network device; and transferring data units from the plurality of ingress queues to the plurality of egress buffer memories of the network device; wherein storing data units received at the plurality of network interfaces in the plurality of egress queues comprises storing data units transferred from the plurality of ingress queues; wherein monitoring the plurality of egress buffer memories comprises monitoring the plurality of egress buffer memories to detect congestion corresponding to data units received from the plurality of ingress queues; wherein sending the first messages to the multiple sources comprises sending the first messages to second circuitry associated with the ingress queues; wherein sending the second messages to the multiple sources comprises sending the second messages to the second circuitry; and wherein limiting the quantity of the second messages that are sent to the multiple sources during the time period comprises limiting the quantity of the second messages that are sent to the second circuitry during the time period.

At least some of the various blocks, operations, and techniques described above are suitably implemented utilizing dedicated hardware, such as one or more of discrete components, an integrated circuit, an ASIC, a programmable logic device (PLD), a processor executing firmware instructions, a processor executing software instructions, or any combination thereof. When implemented utilizing a processor executing software or firmware instructions, the software or firmware instructions may be stored in any suitable computer readable memory such as in a random access memory (RAM), a read-only memory (ROM), a solid state memory, etc. The software or firmware instructions may include machine readable instructions that, when executed by one or more processors, cause the one or more processors to perform various acts described herein.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A network device, comprising:
a plurality of network interfaces;
a plurality of packet processors configured to process data units received via the plurality of network interfaces to determine network interfaces, among the plurality of network interfaces, that are to transmit the data units;
a plurality of buffer memories;
a plurality of queues corresponding to the plurality of buffer memories, the plurality of queues configured to store data units received via the plurality of network interfaces while the data units are being processed by the plurality of packet processors; and
first circuitry configured to:
monitor the plurality of buffer memories to detect congestion corresponding to data units received from a plurality of sources,
in response to detecting congestion corresponding to a first queue among the plurality of queues, send first messages to multiple sources that are sending data units that are being stored in the first queue, the first messages indicating that the multiple sources are to pause sending data units that are destined for the first queue,
in response to determining that the congestion corresponding to the first queue has ended, send second messages to the multiple sources, the second messages indicating that the multiple sources are to resume sending data units that are destined for the first queue, and
limit a quantity of the second messages that are sent to the multiple sources during a time period to a maximum quantity such that one or more second messages are sent to a first subset of sources among the multiple sources during the time period and no second messages are sent to a second subset of sources among the multiple sources during the time period.

2. The network device of claim 1, wherein the circuitry is further configured to:
determine the maximum quantity based on a quantity of sources to which the one or more first messages were sent.

3. The network device of claim 1, wherein the circuitry is further configured to:
determine the maximum quantity based on a status of a buffer memory, among the plurality of buffer memories, in which the first queue is implemented.

4. The network device of claim 1, wherein the circuitry is further configured to:
determine the maximum quantity based on a quantity of egress ports of the network device that are experiencing congestion.

5. The network device of claim 1, wherein the circuitry is further configured to:
determine the maximum quantity pseudorandomly.

6. The network device of claim 1, wherein the circuitry is further configured to:
determine a duration of the time period pseudorandomly.

7. The network device of claim 1, wherein the time period is a first time period, and wherein the circuitry is configured to:
send one or more second messages to one or more sources among the second subset of sources during a second time period that follows the first period.

8. The network device of claim 7, wherein the maximum quantity is a first maximum quantity, and wherein the circuitry is further configured to:
limit a quantity of the second messages that are sent to the multiple sources during the second time period to a second maximum quantity.

9. The network device of claim 8, wherein at least one of i) the first maximum quantity is different than the second maximum quantity, and ii) a first duration of the first time period is different than a second duration of the second time period.

10. The network device of claim 1, wherein the plurality of queues are a plurality of egress queues, wherein the one or more processors are one or more egress packet processors of the network device, wherein the one or more buffer memories are one or more egress buffer memories, wherein the circuitry is first circuitry, and wherein the network device further comprises:
one or more ingress packet processors configured to process data units received via the plurality of network interfaces to determine network interfaces, among the plurality of network interfaces, that are to transmit the data units; and
a plurality of ingress queues configured to store data units received via the plurality of network interfaces while the data units are being processed by the one or more ingress packet processors;
wherein the one or more egress packet processors are configured to process data units received from the plurality of ingress queues;
wherein the one or more egress buffer memories are configured to store data units received from the plurality of ingress queues while the data units are being processed by the one or more egress packet processors, the data units received from the plurality of ingress queues being stored in the plurality of egress queues corresponding to the one or more egress buffer memories; and
wherein the circuitry is configured to:
monitor the plurality of egress buffer memories to detect congestion corresponding to data units received from the plurality of ingress queues,
send the first messages to second circuitry associated with the ingress queues,
send the second messages to the second circuitry, and
limit the quantity of the second messages that are sent to the second circuitry during the time period.

11. A method for processing data units in a network device, the method comprising:
receiving data units at a plurality of network interfaces of the network device;
storing data units received at the plurality of network interfaces in a plurality of queues while the data units are processed by one or more processors of the network device, the plurality of queues corresponding to one or more buffer memories;
monitoring, by the network device, the plurality of buffer memories to detect congestion corresponding to data units received from a plurality of sources;
in response to detecting congestion corresponding to a first queue among the plurality of queues, sending, by circuitry of the network device, first messages to multiple sources that are sending data units that are being stored in the first queue, the first messages indicating that the multiple sources are to pause sending data units that are destined for the first queue;
in response to determining that the congestion corresponding to the first queue has ended, sending, by the circuitry, second messages to the multiple sources, the second messages indicating that the multiple sources are to resume sending data units that are destined for the first queue; and
limiting, by the circuitry, a quantity of the second messages that are sent to the multiple sources during a time period to a maximum quantity such that one or more second messages are sent to a first subset of sources among the multiple sources during the time period and no second messages are sent to a second subset of sources among the multiple sources during the time period.

12. The method of claim 11, further comprising:
determining, by the network device, the maximum quantity based on a quantity of sources to which the one or more first messages were sent.

13. The method of claim 11, further comprising:
determining, by the network device, the maximum quantity based on a status of a buffer memory, among the plurality of buffer memories, in which the first queue is implemented.

14. The method of claim 11, further comprising:
determining, by the network device, the maximum quantity based on a quantity of egress ports of the network device that are experiencing congestion.

15. The method of claim 11, further comprising:
determining, by the network device, the maximum quantity pseudorandomly.

16. The method of claim 11, further comprising:
determining, by the network device, a duration of the time period pseudorandomly.

17. The method of claim 11, wherein the time period is a first time period, and wherein sending the second messages to the multiple sources comprises:
sending one or more second messages to one or more sources among the second subset of sources during a second time period that follows the first period.

18. The method of claim 17, wherein the maximum quantity is a first maximum quantity, and wherein the method further comprises:
limiting, by the network device, a quantity of the second messages that are sent to the multiple sources during the second time period to a second maximum quantity.

19. The method of claim 18, wherein at least one of i) the first maximum quantity is different than the second maximum quantity, and ii) a first duration of the first time period is different than a second duration of the second time period.

20. The method of claim 11, wherein the plurality of queues are a plurality of egress queues, wherein the one or more processors are one or more egress packet processors of the network device, wherein the one or more buffer memories are one or more egress buffer memories, wherein the circuitry is first circuitry, and wherein the method further comprises:
storing data units received at the plurality of network interfaces in a plurality of ingress queues of the network device while the data units are processed by a plurality of ingress packet processors of the network device; and
transferring data units from the plurality of ingress queues to the plurality of egress buffer memories of the network device;
wherein storing data units received at the plurality of network interfaces in the plurality of egress queues comprises storing data units transferred from the plurality of ingress queues;
wherein monitoring the plurality of egress buffer memories comprises monitoring the plurality of egress buffer memories to detect congestion corresponding to data units received from the plurality of ingress queues;
wherein sending the first messages to the multiple sources comprises sending the first messages to second circuitry associated with the ingress queues;
wherein sending the second messages to the multiple sources comprises sending the second messages to the second circuitry; and
wherein limiting the quantity of the second messages that are sent to the multiple sources during the time period comprises limiting the quantity of the second messages that are sent to the second circuitry during the time period.
